(19) United States
(12) Patent Application Publication
(10) Pub. No.: US 2020/0267269 A1
(43) Pub. Date: Aug. 20, 2020

(54) MULTIFUNCTIONAL APPARATUS

(71) Applicant: SHARP KABUSHIKI KAISHA, Sakai City (JP)

(72) Inventors: TOMOYA USUI, Sakai City (JP); TOHRU NISHIKAWA, Sakai City (JP)

(21) Appl. No.: 16/788,053

(22) Filed: Feb. 11, 2020

(30) Foreign Application Priority Data
Feb. 20, 2019 (JP) 2019-028934

(51) Int. Cl. H04N 1/00; G06F 3/12; G06F 3/041

(52) U.S. Cl. CPC H04N 1/00411; H04N 1/00129; G06F 3/0412; G06F 3/12; H04N 1/00352

(57) ABSTRACT

A multifunctional apparatus includes an operation panel on which a touch panel and a hardware button are arranged. An external recording medium slot is arranged on the operation panel having a predetermined relationship with the largest-sized software key arranged on the touch panel or the largest-sized hardware button arranged on the operation panel.

### BACKGROUND OF THE INVENTION

### Field of the Invention

The present invention relates to a multifunctional apparatus.

### Description of the Background Art

A multifunctional apparatus is an apparatus including an image reading device, an image forming device, a facsimile transmission and reception device, a storage device, and the like, to perform image reading, image printing, image copying, image transmission, and the like. A certain percentage of multifunctional apparatuses have an external recording medium slot such as a Universal Serial Bus (USB) slot. Such a multifunctional apparatus can read an image data file, a document file, and the like from a USB memory inserted into the USB slot, and can also print an image or a document based on the file (see Japanese Patent No. 4233293).

Conventional external recording medium slots such as USB memory slots are often provided away from an operation panel, for example, at the front and side faces of a main body. For this reason, in a case where a user inserts a USB memory into the USB memory slot and then leaves the USB memory behind even after using the USB memory, there is a risk that information recorded in the USB memory may be leaked to another person.

It is noted that this problem is true of not only USB memory slots but also other types of external recording medium slots such as SD card memory slots, Compact Flash (registered trademark) memory slots, and multimedia memory card slots.

An object of the present invention is to provide a multifunctional apparatus having an external recording medium slot capable of preventing a user from leaving a memory card inserted therein behind after the user uses the memory card.

### SUMMARY OF THE INVENTION

According to the present invention, provided is a multifunctional apparatus including an operation panel on which a touch panel and a hardware button are arranged, wherein an external recording medium slot is arranged on the operation panel having a predetermined relationship with a largest-sized software key arranged on the touch panel or a largest-sized hardware button arranged on the operation panel.

According to the present invention, a user can easily visually recognize a memory card inserted into an external recording medium slot, so that it is possible to prevent the user from leaving the inserted memory card behind after the user uses the card.

### BRIEF DESCRIPTION OF THE DRAWINGS

FIG. 1 illustrates a front view, a top view, and a right side view of a configuration of a multifunctional apparatus according to a first embodiment of the present invention;

FIG. 2 illustrates a plan view, a front view, and a right side view of a configuration of an operation panel of the multifunctional apparatus according to the first embodiment of the present invention;

FIG. 3 illustrates a plan view, a front view, and a right side view of a configuration of an operation panel of a multifunctional apparatus according to a second embodiment of the present invention;

FIG. 4 illustrates a plan view, a front view, and a right side view of a configuration of an operation panel of a multifunctional apparatus according to a third embodiment of the present invention;

FIG. 5 illustrates a plan view, a front view, and a right side view of a configuration near an operation panel of a multifunctional apparatus according to a fourth embodiment of the present invention;

FIG. 6 illustrates a plan view, a front view, and a right side view of a configuration near an operation panel of a multifunctional apparatus according to a fifth embodiment of the present invention;

FIG. 7 illustrates a plan view, a front view, and a right side view of a configuration of an operation panel of a multifunctional apparatus according to a sixth embodiment of the present invention;

FIG. 8 illustrates a plan view, a front view, and a right side view of a configuration of an operation panel of a multifunctional apparatus according to a seventh embodiment of the present invention;

FIG. 9 illustrates a plan view, a front view, and a right side view of a configuration of an operation panel of a multifunctional apparatus according to an eighth embodiment of the present invention;

FIG. 10 illustrates a plan view, a front view, and a right side view of a configuration of an operation panel of a multifunctional apparatus according to a ninth embodiment of the present invention;

FIG. 11 illustrates a plan view, a front view, and a right side view of a configuration of an operation panel of a multifunctional apparatus according to a tenth embodiment of the present invention;

FIG. 12 illustrates a plan view, a front view, and a right side view of a configuration of an operation panel of a multifunctional apparatus according to an eleventh embodiment of the present invention;

FIG. 13 illustrates a plan view, a front view, and a right side view of a configuration of an operation panel of a multifunctional apparatus according to a twelfth embodiment of the present invention;

FIG. 14 illustrates a right side view of a configuration of a multifunctional apparatus according to a thirteenth embodiment of the present invention;

FIG. 15 illustrates a plan view, a front view, and a right side view of a configuration of an operation panel of a multifunctional apparatus according to a fourteenth embodiment of the present invention;

FIG. 16 illustrates a plan view, a front view, and a right side view of a configuration of an operation panel of a multifunctional apparatus according to a fifteenth embodiment of the present invention;

FIG. 17 illustrates a plan view, a front view, and a right side view of a configuration of an operation panel of a multifunctional apparatus according to a sixteenth embodiment of the present invention;

FIG. 18 illustrates a plan view, a front view, and a right side view of a configuration of an operation panel of a multifunctional apparatus according to a seventeenth embodiment of the present invention;

FIG. 19 illustrates a front view, a top view, and a right side view of a configuration of a multifunctional apparatus according to an eighteenth embodiment of the present invention;

FIG. 20 illustrates a front view, a top view, and a right side view of another configuration of a multifunctional apparatus according to the eighteenth embodiment of the present invention;

FIG. 21 illustrates a front view, a top view, and a right side view of a configuration of a multifunctional apparatus according to a nineteenth embodiment of the present invention;

FIG. 22 illustrates a front view, a top view, and a right side view of another configuration of a multifunctional apparatus according to the nineteenth embodiment of the present invention;

FIG. 23 illustrates a front view of a configuration of a multifunctional apparatus according to a twentieth embodiment of the present invention, a plan view, a front view, and a right side view of a configuration of an operation panel of the multifunctional apparatus, and an enlarged view of a USB slot;

FIG. 24 illustrates a front view of a configuration of a multifunctional apparatus according to a twenty-first embodiment of the present invention, a plan view, a front view, and a right side view of a configuration of an operation panel of the multifunctional apparatus, and an enlarged view of a USB slot;

FIG. 25 illustrates a front view, a top view, and a right side view of a configuration of a multifunctional apparatus according to a twenty-second embodiment of the present invention;

FIG. 26 illustrates a front view, a top view, and a right side view of a configuration of a multifunctional apparatus according to a twenty-third embodiment of the present invention;

FIG. 27 illustrates a front view, a top view, and a right side view of a configuration of a multifunctional apparatus according to a twenty-fourth embodiment of the present invention;

FIG. 28 illustrates a front view, a top view, and a right side view of a configuration of a multifunctional apparatus according to a twenty-fifth embodiment of the present invention;

FIG. 29 illustrates a front view, a top view, and a right side view of a configuration of a multifunctional apparatus according to a twenty-sixth embodiment of the present invention;

FIG. 30 illustrates a conceptual cross-sectional view of a multifunctional apparatus according to a twenty-seventh embodiment of the present invention; and

FIG. 31 illustrates a functional block diagram of the multifunctional apparatus according to the twenty-seventh embodiment of the present invention.

### DESCRIPTION OF THE PREFERRED EMBODIMENTS

Embodiments for carrying out the present invention will be described in detail with reference to the drawings below.

### First Embodiment

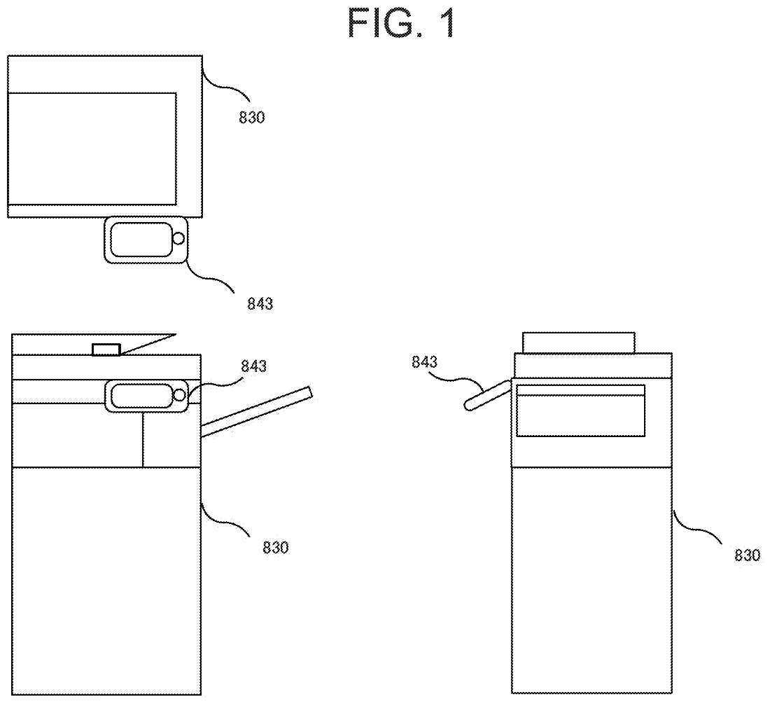

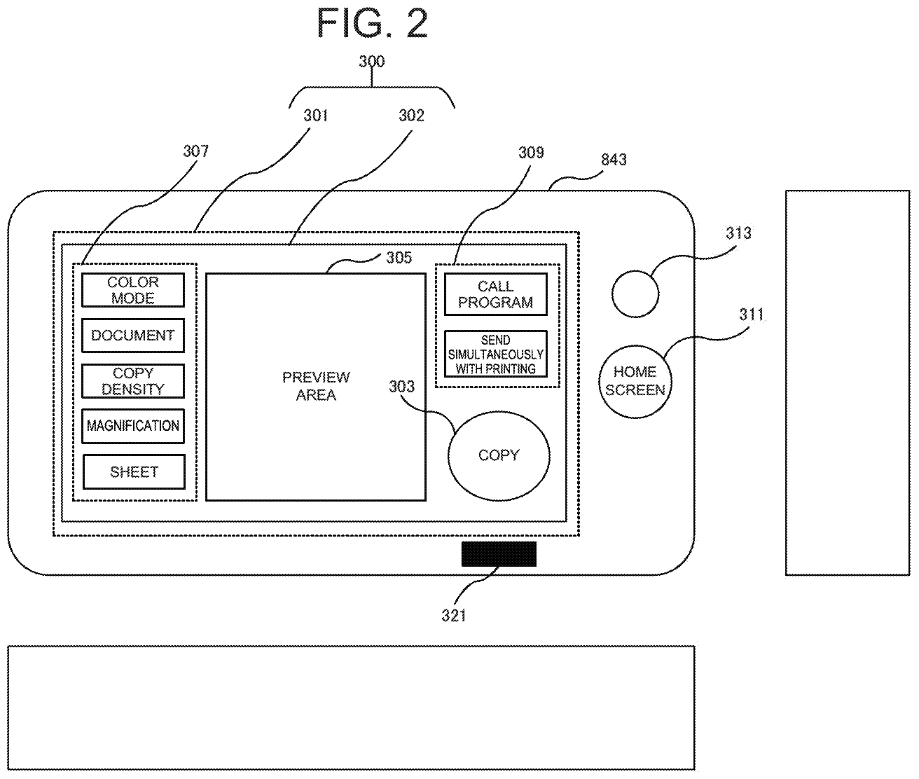

In a first embodiment, as illustrated in FIG. 1, an operation panel 843 is provided on a top right side of a front face of a main body 830. Further, as illustrated in FIG. 2, a touch panel 300, a home screen button 311, and a power button 313 are arranged on the top face of the operation panel 843.

On the touch panel 300, a display area 301 and a touch area 302 are provided. In the example of FIG. 2, the touch area 302 is provided in a portion excluding the vicinity of the outer edge of the display area 301. However, the display area 301 and the touch area 302 may be the same, or contrary to the example of FIG. 2, the display area 301 may be provided in a portion excluding the vicinity of the outer edge of the touch area 302. Such a relationship between the display area 301 and the touch area 302 is the same in other embodiments.

On the touch panel 300, a copy key 303, a preview area 305, a setting key group 307, and a job key group 309 are provided.

The setting key group 307 includes a color mode key, a document key, a copy density key, a magnification key, and a sheet key. The job key group 309 includes a program call key and a sending-simultaneously-with-printing key.

Here, the home screen button 311 and the power button 313 are hardware buttons, and the copy key 303, the keys included in the setting key group 307, and the keys included in the job key group 309 are software keys.

In addition, a USB slot 321 is arranged in the periphery of the touch panel 300 on the top face of the operation panel 843. In particular, the arrangement of the USB slot 321 is designed so that the software key closest to the USB slot 321 of all the software keys arranged on the touch panel 300 is the largest of all the software keys arranged on the touch panel 300. Specifically, the position of the USB slot 321 is adjusted so that the software key closest to the USB slot 321 of the copy key 303 and the keys included in the setting key group 307 and the job key group 309 arranged on the touch panel 300 is the copy key 303, which is the largest of all the software keys arranged on the touch panel 300.

### Second Embodiment

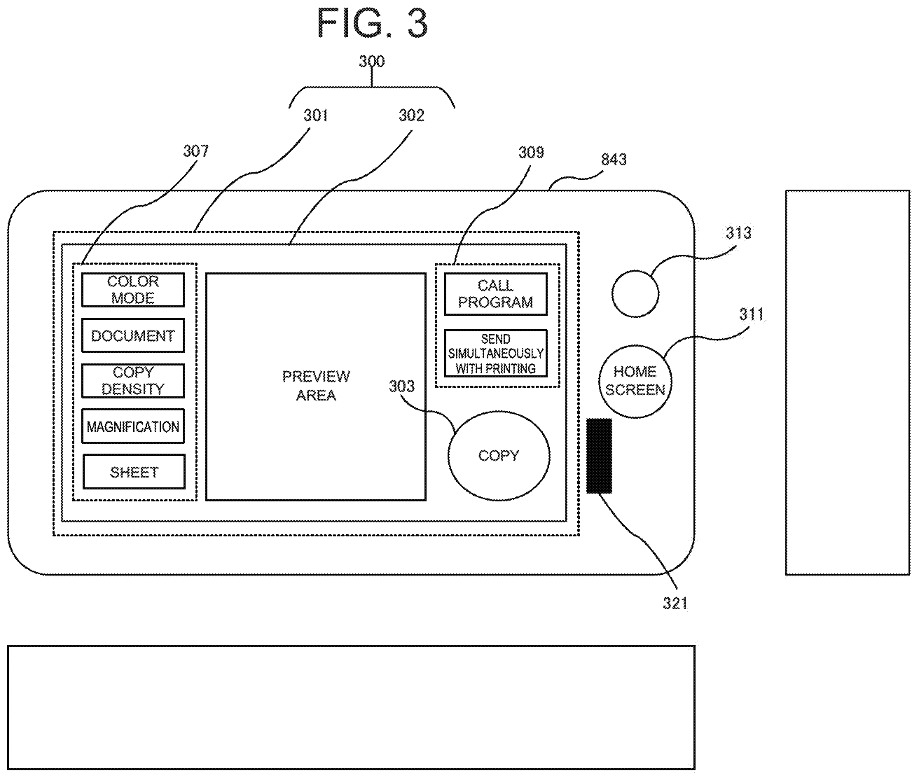

The top face, front side face, and right side face of the touch panel 300 according to a second embodiment are as illustrated in FIG. 3.

Also in the second embodiment, as in the first embodiment, the USB slot 321 is arranged in the periphery of the touch panel 300 on the top face of the operation panel 843. In particular, the arrangement of the USB slot 321 is designed so that the software key closest to the USB slot 321 of all the software keys arranged on the touch panel 300 is the largest of all the software keys arranged on the touch panel 300. Specifically, the position of the USB slot 321 is adjusted so that the software key closest to the USB slot 321 of the copy key 303 and the keys included in the setting key group 307 and the job key group 309 arranged on the touch panel 300 is the copy key 303, which is the largest of all the software keys arranged on the touch panel 300.

In the first embodiment, the USB slot 321 is arranged in the vicinity of the lower side of the touch panel 300. By contrast, in the second embodiment, the USB slot 321 is arranged in the vicinity of the right side of the touch panel 300.

### Third Embodiment

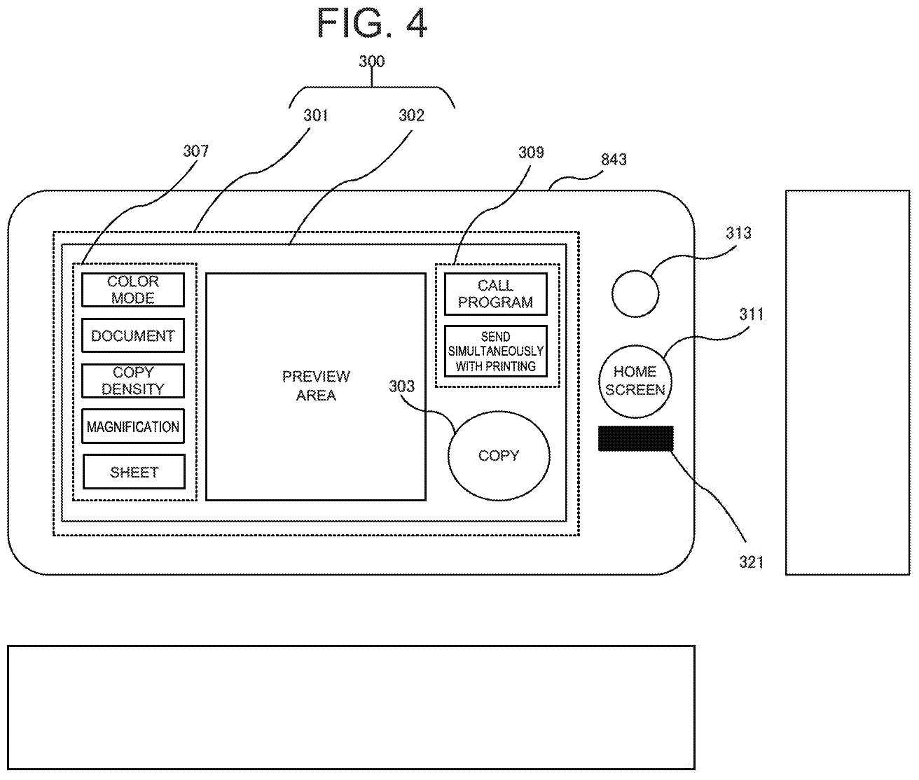

The top face, front side face, and right side face of the touch panel 300 according to a third embodiment are as illustrated in FIG. 4.

In the third embodiment, the USB slot 321 is arranged in a region other than the touch panel 300 on the top face of the operation panel 843. In particular, the arrangement of the USB slot 321 is designed so that the button closest to the USB slot 321 of all the hard buttons including a home screen button 311 and a power button 313 which are arranged on the operation panel 843 is the largest of the hard buttons arranged on the operation panel 843. Specifically, the arrangement of the USB slot 321 is designed so that the button closest to the USB slot 321 of the home screen button 311 and the power button 313 arranged on the operation panel 843 is the home screen button 311, which is the largest of the home screen button 311 and the power button 313 arranged on the operation panel 843.

### Fourth Embodiment

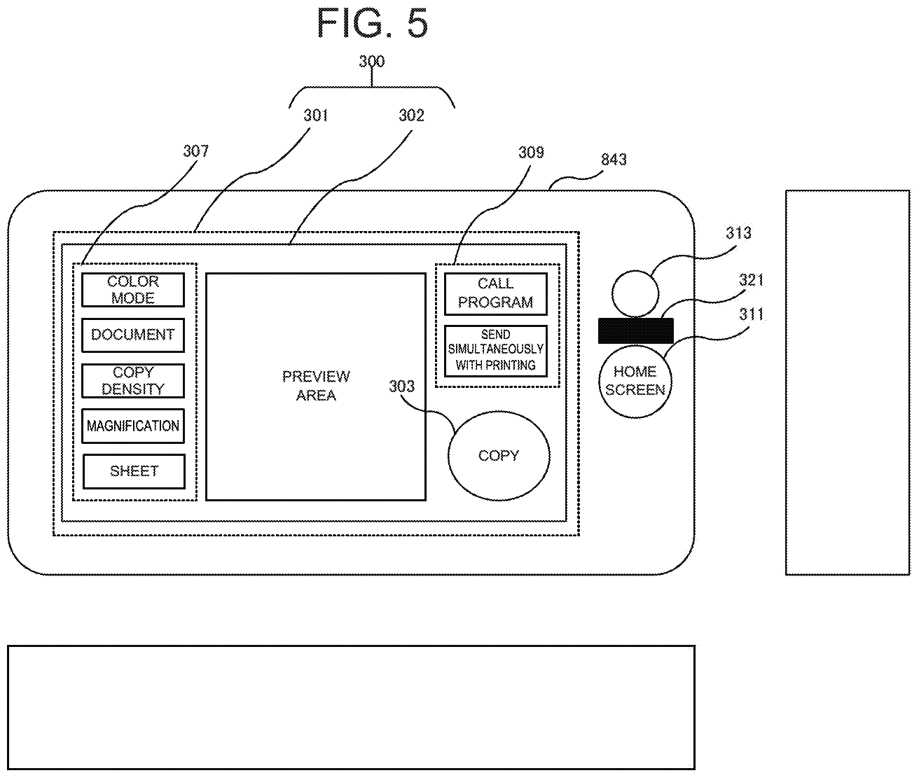

The top face, front side face, and right side face of the touch panel 300 according to a fourth embodiment are as illustrated in FIG. 5.

In the fourth embodiment, the USB slot 321 is arranged in a region other than the touch panel 300 on the top face of the operation panel 843. In particular, the arrangement of the USB slot 321 is designed so that the button closest to the USB slot 321 of all the hard buttons including a home screen button 311 and a power button 313 which are arranged on the operation panel 843 is the largest of the hard buttons arranged on the operation panel 843. Specifically, the arrangement of the USB slot 321 is designed so that the button closest to the USB slot 321 of the home screen button 311 and the power button 313 arranged on the operation panel 843 is the home screen button 311, which is the largest of the home screen button 311 and the power button 313 arranged on the operation panel 843.

In the third embodiment, the USB slot 321 is arranged below the home screen button 311. By contrast, in the fourth embodiment, the USB slot 321 is arranged above the home screen button 311.

### Fifth Embodiment

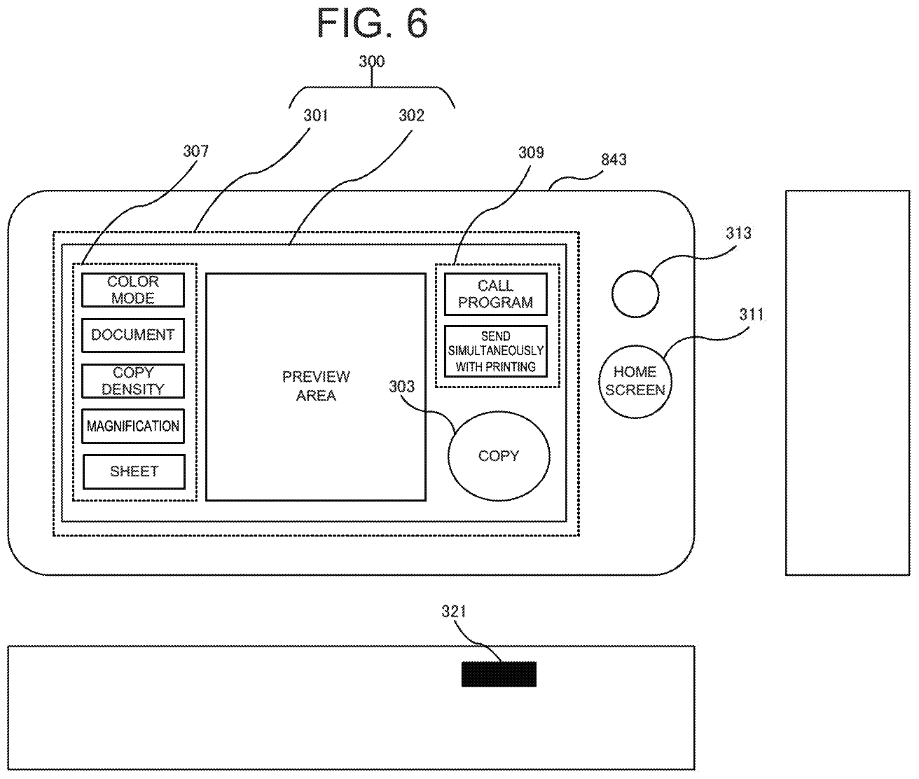

The top face, front side face, and right side face of the touch panel 300 according to a fifth embodiment are as illustrated in FIG. 6.

In the fifth embodiment, the USB slot 321 is arranged in the periphery of the touch panel 300 on the front side face of the operation panel 843. In particular, the arrangement of the USB slot 321 is designed so that the software key closest to the USB slot 321 of all the software keys arranged on the touch panel 300 is the largest of all the software keys arranged on the touch panel 300. Specifically, the position of the USB slot 321 is adjusted so that the software key closest to the USB slot 321 of the copy key 303 and the keys included in the setting key group 307 and the job key group 309 arranged on the touch panel 300 is the copy key 303, which is the largest of all the software keys arranged on the touch panel 300.

### Sixth Embodiment

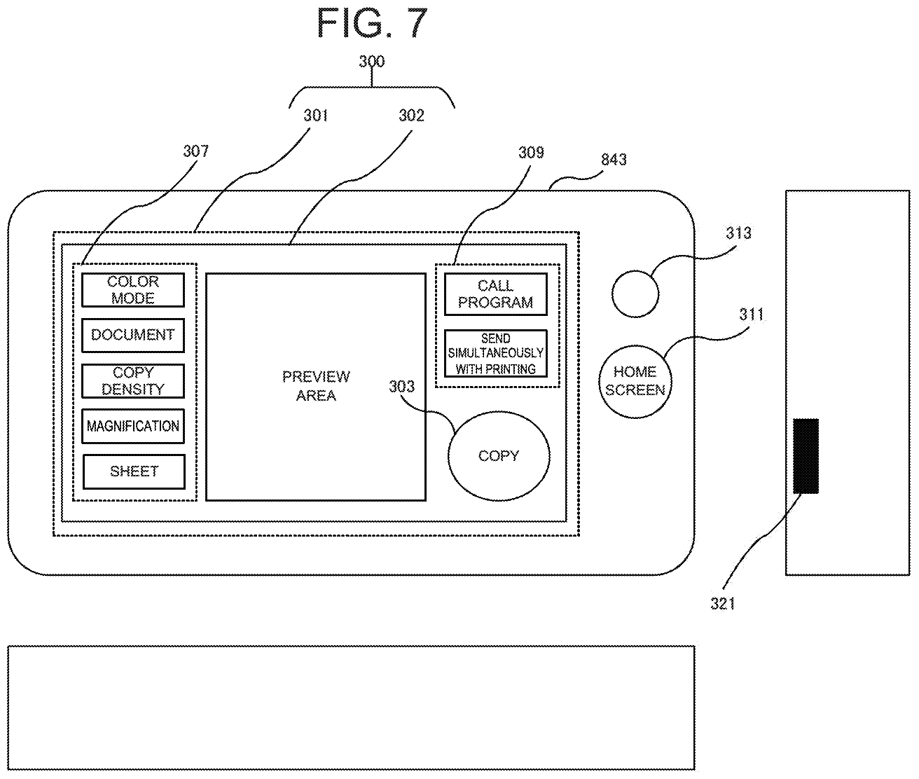

The top face, front side face, and right side face of the touch panel 300 according to a sixth embodiment are as illustrated in FIG. 7.

In the sixth embodiment, the USB slot 321 is arranged in the periphery of the touch panel 300 on the right side face of the operation panel 843. In particular, the arrangement of the USB slot 321 is designed so that the software key closest to the USB slot 321 of all the software keys arranged on the touch panel 300 is the largest of all the software keys arranged on the touch panel 300. Specifically, the position of the USB slot 321 is adjusted so that the software key closest to the USB slot 321 of the copy key 303 and the keys included in the setting key group 307 and the job key group 309 arranged on the touch panel 300 is the copy key 303, which is the largest of all the software keys arranged on the touch panel 300.

### Seventh Embodiment

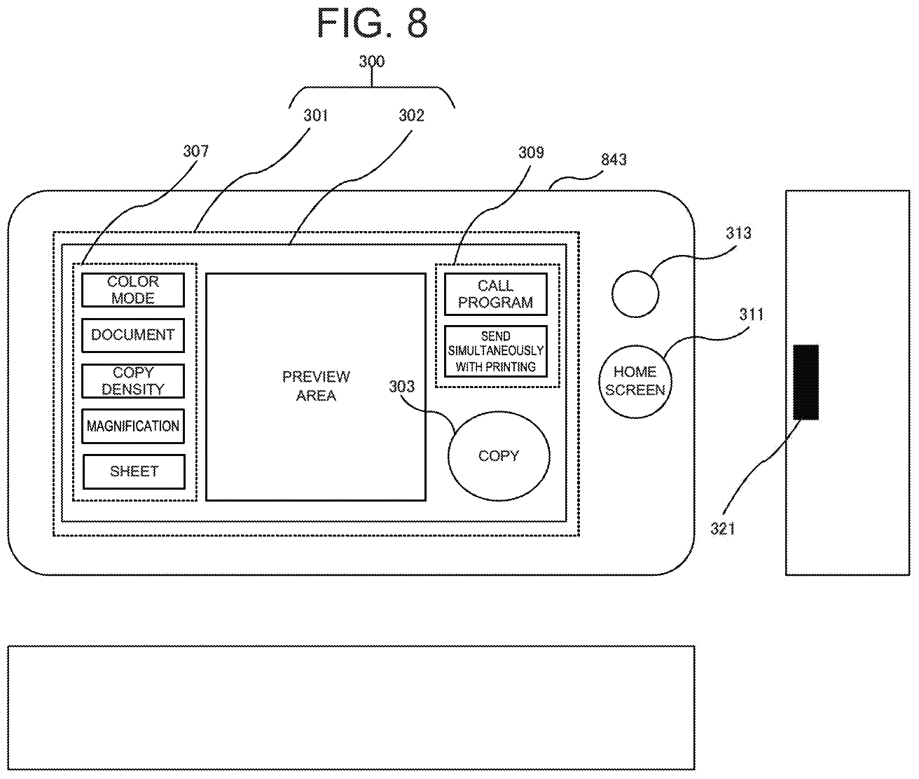

The top face, front side face, and right side face of the touch panel 300 according to a seventh embodiment are as illustrated in FIG. 8.

In the seventh embodiment, the USB slot 321 is arranged in a region other than the touch panel 300 on the right side face of the operation panel 843. In particular, the arrangement of the USB slot 321 is designed so that the button closest to the USB slot 321 of all the hard buttons including a home screen button 311 and a power button 313 which are arranged on the operation panel 843 is the largest of the hard buttons arranged on the operation panel 843. Specifically, the arrangement of the USB slot 321 is designed so that the button closest to the USB slot 321 of the home screen button 311 and the power button 313 arranged on the operation panel 843 is the home screen button 311, which is the largest of the home screen button 311 and the power button 313 arranged on the operation panel 843.

### Eighth Embodiment

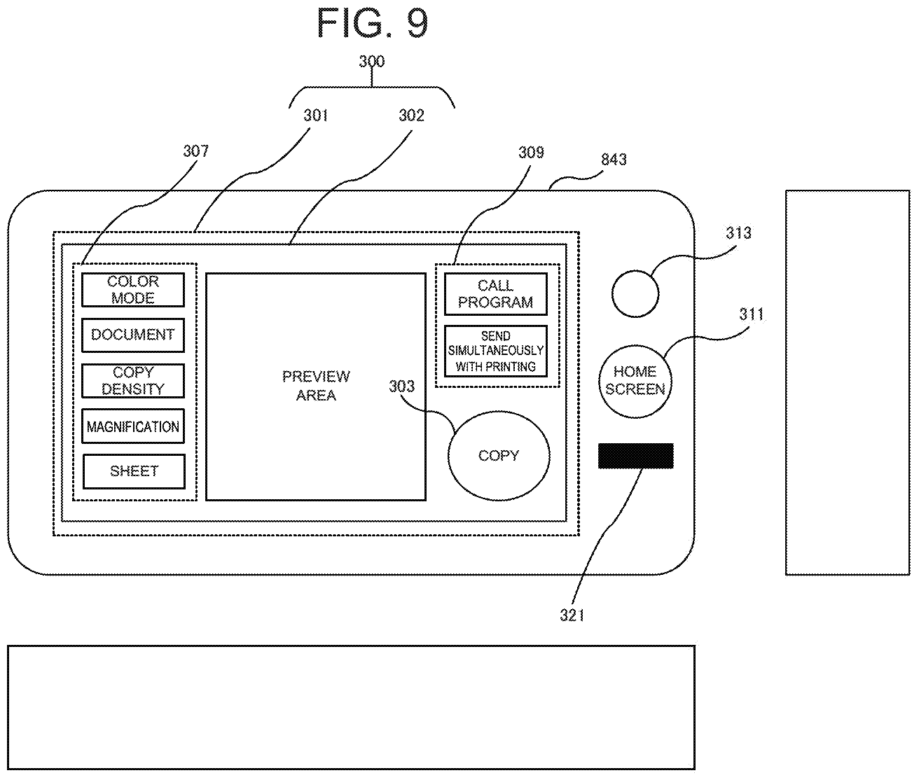

The top face, front side face, and right side face of the touch panel 300 according to an eighth embodiment are as illustrated in FIG. 9.

In the eighth embodiment, the USB slot 321 is arranged in a region other than the touch panel 300 on the top face of the operation panel 843. In particular, the arrangement of the USB slot 321 is designed so that the following two conditions are satisfied. The first condition is that the software key closest to the USB slot 321 of all the software keys arranged on the touch panel 300 is the largest of all the software keys arranged on the touch panel 300. The second condition is that the button closest to the USB slot 321 of all the hard buttons including a home screen button 311 and a power button 313 which are arranged on the operation panel 843 is the largest of the hard buttons arranged on the operation panel 843.

Specifically, the arrangement of the USB slot 321 is designed so that the following two conditions are satisfied. The first condition is that the software key closest to the USB slot 321 of the copy key 303 and the keys included in the setting key group 307 and the job key group 309 arranged on the touch panel 300 is the copy key 303, which is the largest of all the software keys arranged on the touch panel 300. The second condition is that the button closest to the USB slot 321 of the home screen button 311 and the power button 313 arranged on the operation panel 843 is the home screen button 311, which is the largest of the home screen button 311 and the power button 313 arranged on the operation panel 843.

### Ninth Embodiment

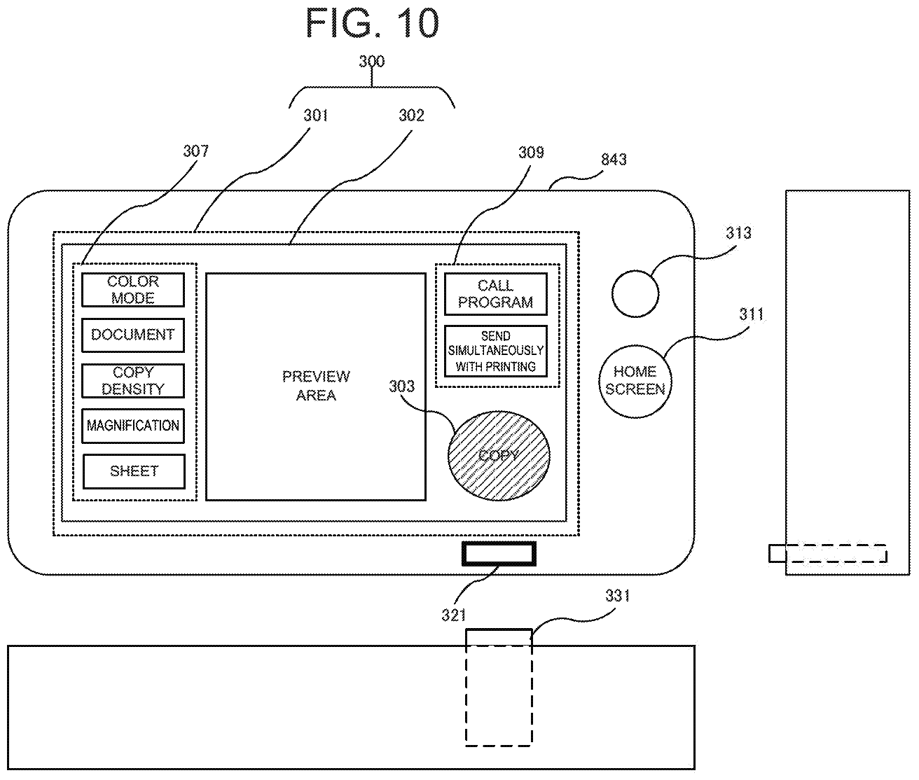

In a ninth embodiment, as illustrated in FIG. 10, if a USB device 331 such as a USB memory is inserted into the USB slot 321, the color of the copy key 303, which is the largest of the software keys arranged on the touch panel 300 changes from a normal color to another color. Alternatively or additionally, another display mode such as a pattern may be changed.

An LED may be arranged in the main body of the largest-sized hardware key or its periphery so that the LED can emit light.

This is applicable to the first to eighth embodiments and other possible embodiments.

### Tenth Embodiment

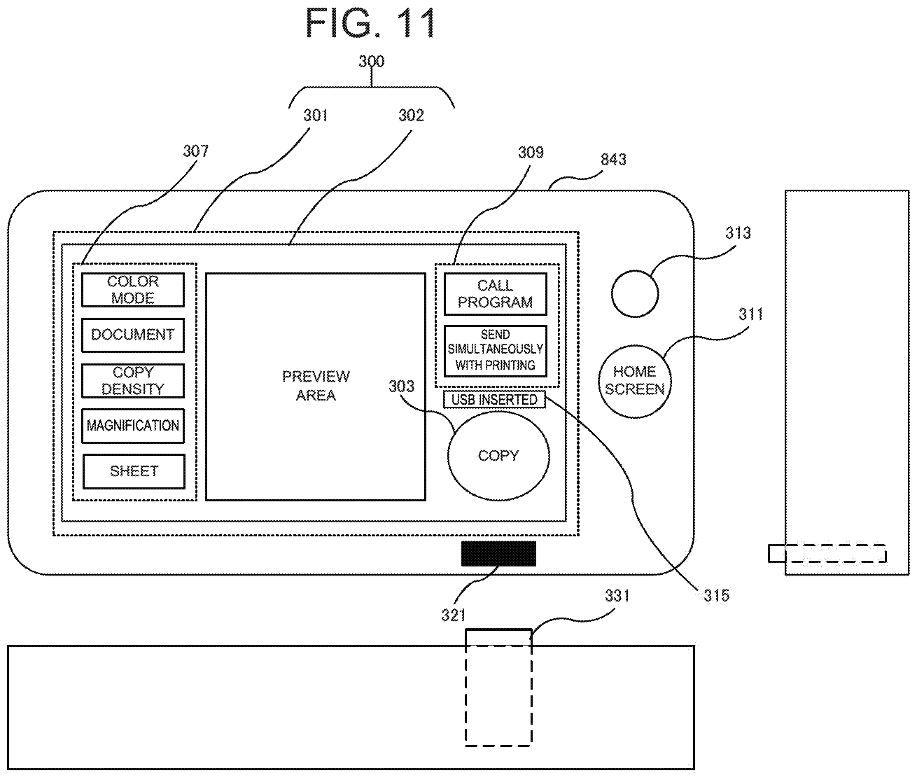

In a tenth embodiment, as illustrated in FIG. 11, if the USB device 331 such as a USB memory is inserted into the USB slot 321, an icon is displayed at a position close to the copy key 303, which is the largest of the software keys arranged on the touch panel 300, to indicate that the USB device 331 has been inserted into the USB slot 321. For example, the icon is accompanied with a text message of “USB inserted”.

In place of the icon, another indication object (button, text, graphics, etc.) may be used.

If an object such as an icon indicating that the USB is has been inserted is displayed according to the present embodiment, the USB slot may be arranged at any position. In other words, the USB slot may be arranged at a position different from the position described in the first to ninth embodiments.

### Eleventh Embodiment

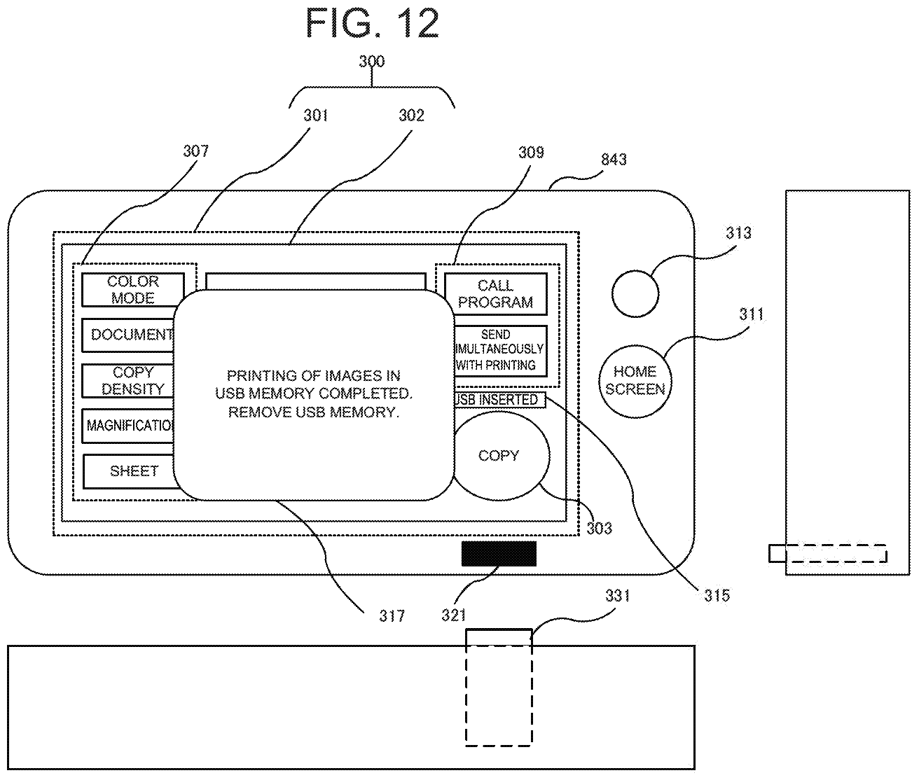

In an eleventh embodiment, as illustrated in FIG. 12, if the USB device 331 such as a USB memory is inserted into the USB slot 321, and then a print job based on image data and document data stored in the USB device 331 is completed, a pop-up window 317 indicating that the print job is completed is displayed at a center of the touch panel 300. The pop-up window 317 is accompanied with a text message of, for example, “Printing of images in USB memory completed. Remove the USB memory.”

In addition, as illustrated in FIG. 12, overlapping the pop-up window 317 with, for example, a part of the copy key 303 which is the largest software key makes the user more easily aware of the pop-up window. In particular, if the overlapping region is wide, the region of the software key hidden by the pop-up window is also widened. This makes a large difference between before and after being hidden, resulting in making the user more easily aware of the pop-up window.

This is applicable to the first to tenth embodiments and other possible embodiments.

### Twelfth Embodiment

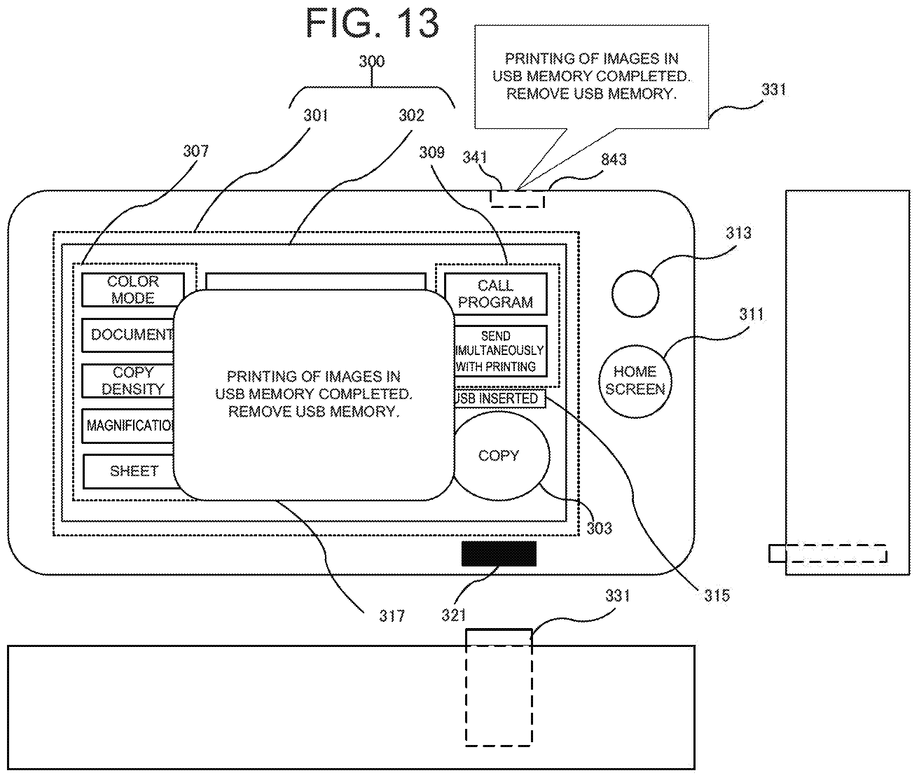

In a twelfth embodiment, as illustrated in FIG. 13, if the USB device 331 such as a USB memory is inserted into the USB slot 321, and then a print job based on image data and document data stored in the USB device 331 is completed, a voice message 331 indicating that the print job is completed is output from a speaker 341. A text message to be read aloud as the voice message 331 is, for example, “Printing of images in USB memory completed. Remove USB memory.”

As illustrated in FIG. 13, the pop-up window 317 according to the eleventh embodiment may or may not be displayed.

The speaker 341 may be attached to the operation panel 843 as illustrated in FIG. 13, and at that time, the speaker 341 may be directed upward so that the user can hear more easily.

This is applicable to the first to eleventh embodiments and other possible embodiments.

### Thirteenth Embodiment

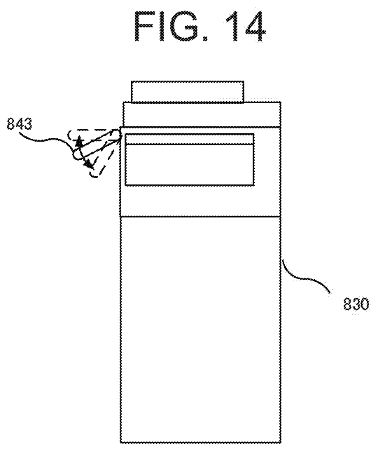

In a thirteenth embodiment, as illustrated in FIG. 14, the operation panel 843 can be tilted about the vicinity of its upper side as a fulcrum. This makes it possible to prevent dust and dirt from accumulating in the operation panel 843 and the USB slot 321 arranged in the operation panel 843.

This is applicable to the first to twelfth embodiments and other possible embodiments.

### Fourteenth Embodiment

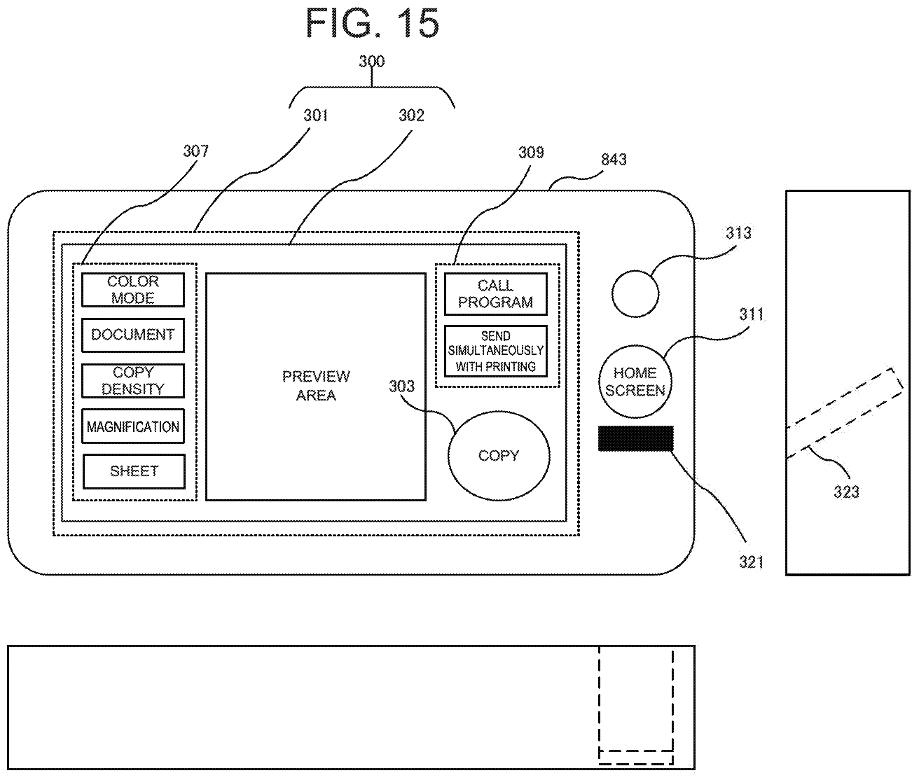

In a fourteenth embodiment, as illustrated in FIG. 15, a USB storage 323 is arranged in the operation panel 843. The USB storage 323 has the USB slot 321 serving as an entrance, and extends diagonally downward as viewed from the side in the operation panel 843. Thus, as illustrated in FIG. 1, in a state where the operation panel 843 is attached to the main body 830, the USB storage 323 extends in a direction close to the vertical direction.

This is applicable to the first to thirteenth embodiments and other possible embodiments.

### Fifteenth Embodiment

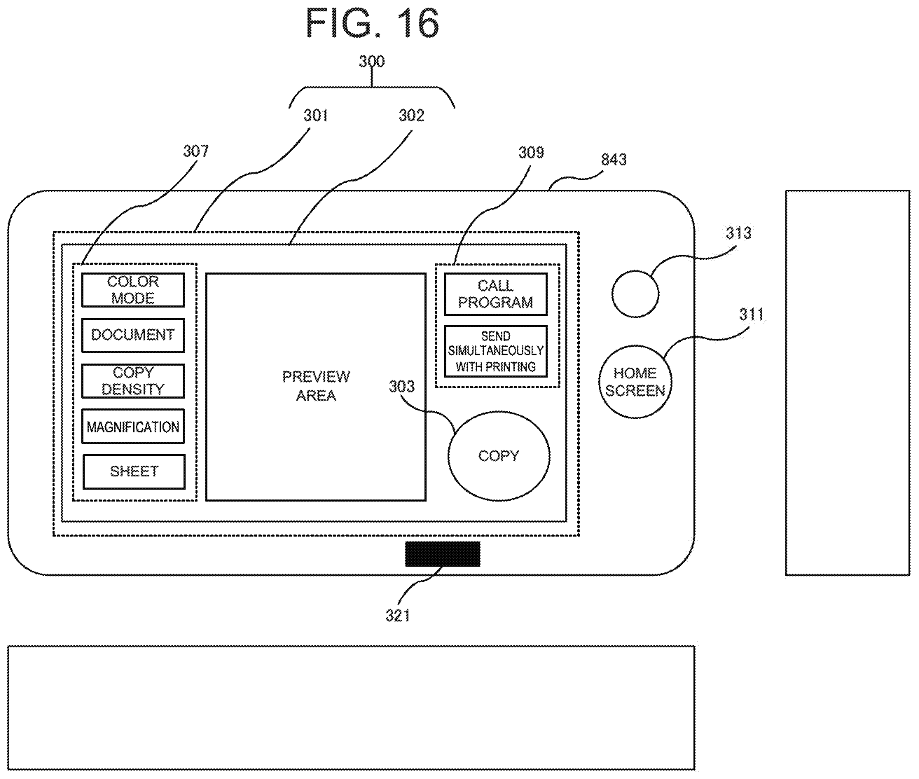

The top face, front side face, and right side face of the touch panel 300 according to a fifteenth embodiment are as illustrated in FIG. 16.

In the fifteenth embodiment, the USB slot 321 is arranged in the periphery of the touch panel 300 on the top face of the operation panel 843. In particular, the arrangement of the USB slot 321 is designed so that the following two conditions are satisfied. The first condition is that the software key closest to the USB slot 321 of all the software keys arranged on the touch panel 300 is the largest of all the software keys arranged on the touch panel 300. The second condition is that the USB slot 321 is arranged, in the periphery of the touch panel 300, close to a position between the software key closest to the USB slot 321 and a preview area 302 on the touch panel 300.

Specifically, the arrangement of the USB slot 321 is designed so that the following two conditions are satisfied. The first condition is that the software key closest to the USB slot 321 of all the software keys arranged on the touch panel 300 is the copy key 303, which is the largest of all the software keys arranged on the touch panel 300. The second condition is that the USB slot 321 is arranged, in the periphery of the touch panel 300, close to a position between the copy key 303, which is the software key closest to the USB slot 321, and the preview area 302 on the touch panel 300.

### Sixteenth Embodiment

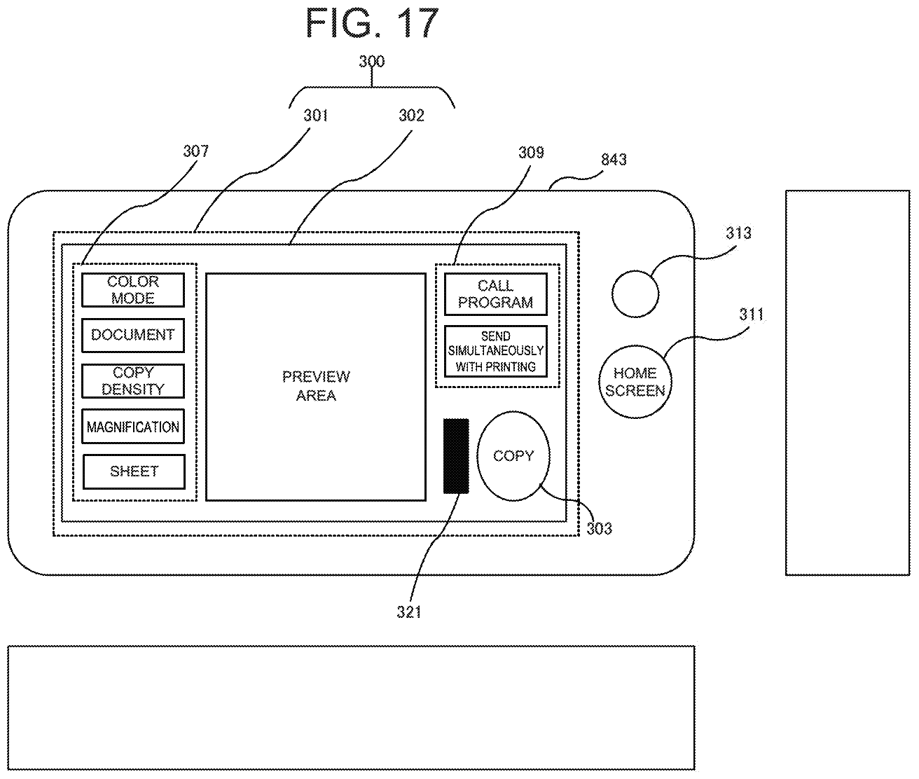

The top face, front side face, and right side face of the touch panel 300 according to a sixteenth embodiment are as illustrated in FIG. 17.

In the sixteenth embodiment, the USB slot 321 is arranged in the touch panel 300 on the top face of the operation panel 843. In particular, the arrangement of the USB slot 321 is designed so that the following two conditions are satisfied. The first condition is that the software key closest to the USB slot 321 of all the software keys arranged on the touch panel 300 is the largest of all the software keys arranged on the touch panel 300. The second condition is that the USB slot 321 is arranged between the software key closest to the USB slot 321 and the preview area 302 on the touch panel 300.

Specifically, the arrangement of the USB slot 321 is designed so that the following two conditions are satisfied. The first condition is that the software key closest to the USB slot 321 of all the software keys arranged on the touch panel 300 is the copy key 303, which is the largest of all the software keys arranged on the touch panel 300. The second condition is that the USB slot 321 is arranged between the copy key 303, which is the software key closest to the USB slot 321, and the preview area 302 on the touch panel 300.

### Seventeenth Embodiment

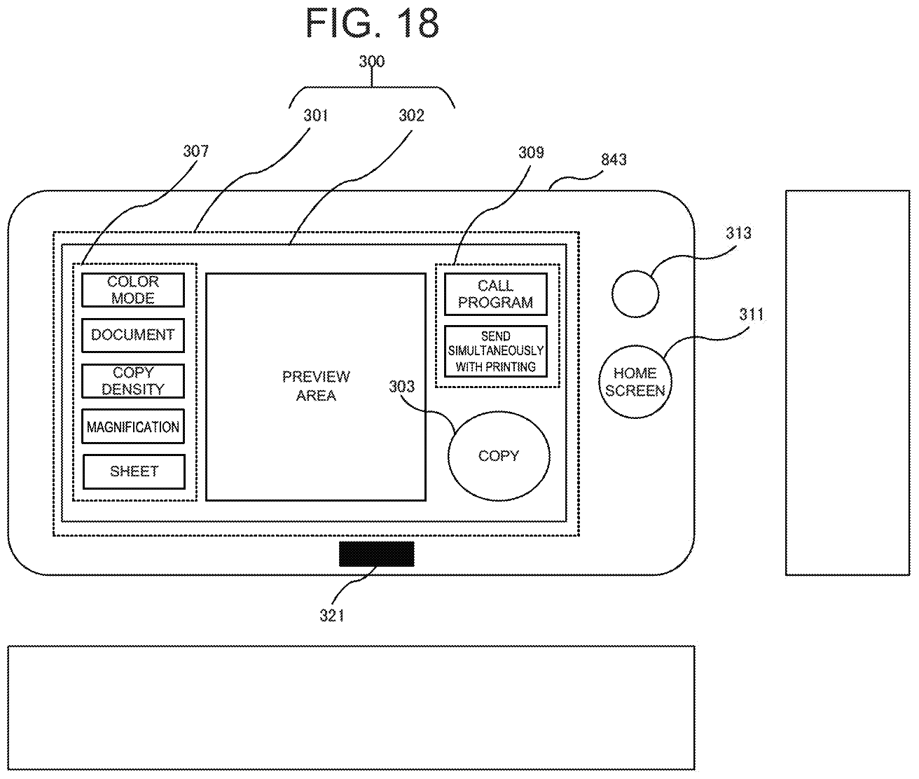

The top face, front side face, and right side face of the touch panel 300 according to a seventeenth embodiment are as illustrated in FIG. 18.

In the seventeenth embodiment, the USB slot 321 is arranged in the periphery of the touch panel 300 on the top face of the operation panel 843. In particular, the position of the USB slot 321 is adjusted so that the USB slot 321 is arranged, in the periphery of the touch panel 300, close to the preview area 302 in the touch panel 300.

### Eighteenth Embodiment

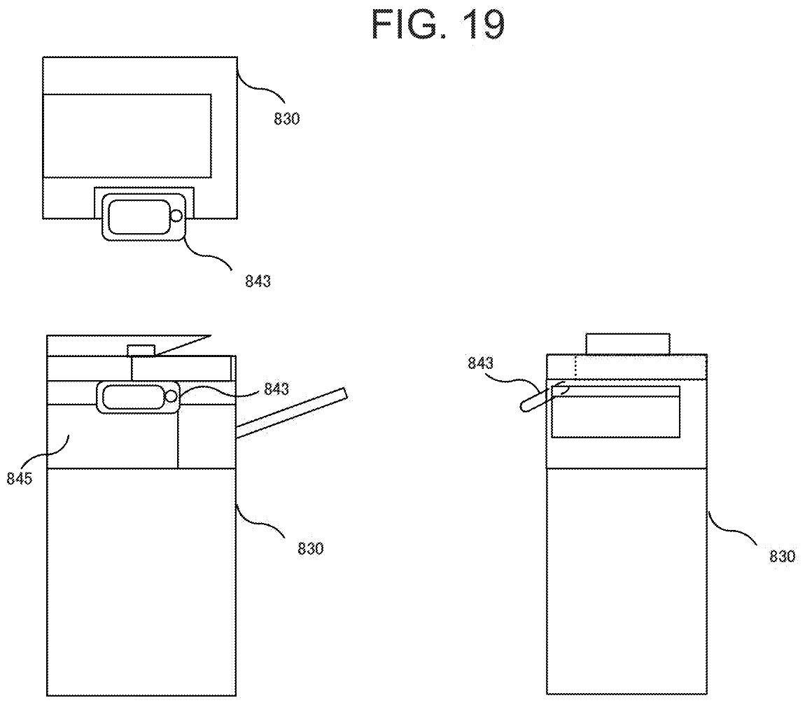

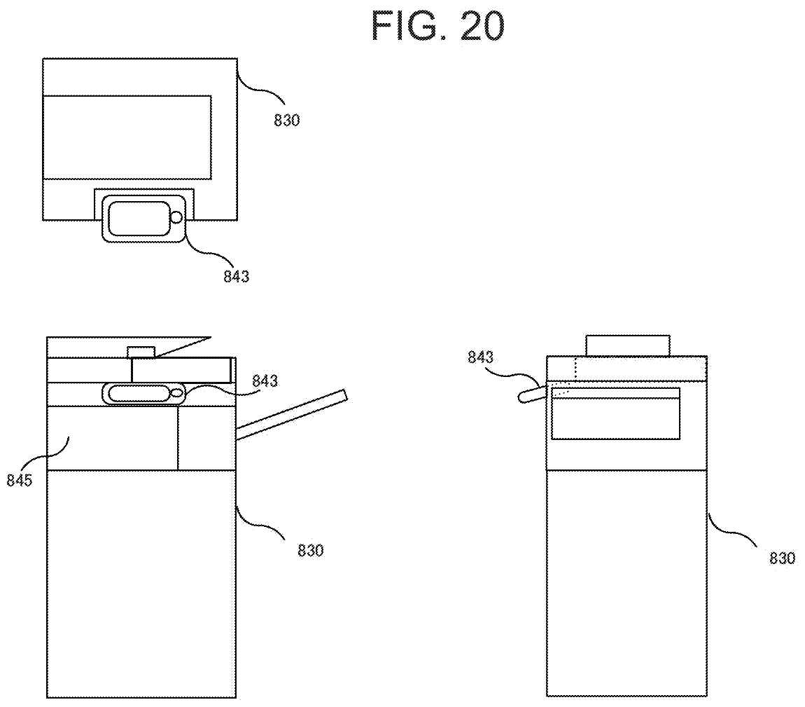

In the eighteenth embodiment, as illustrated in FIG. 19 or FIG. 20, the operation panel 843 is provided across from a top center of the front face to a front center of the top face of the main body 830.

In the example illustrated in FIG. 19, the operation panel 843 hides a part of the entrance of a sheet discharger 845, but in the example illustrated in FIG. 20, the operation panel 843 does not hide a part of the entrance of the sheet discharger 845.

According to the present embodiment, the operation panel 843 is arranged to overlap with the sheet discharger 845 in the horizontal direction. Therefore, when the user takes out a printed copy sheet, the user easily visually recognizes a USB device inserted in the USB slot 321 arranged in the operation panel 843.

### Nineteenth Embodiment

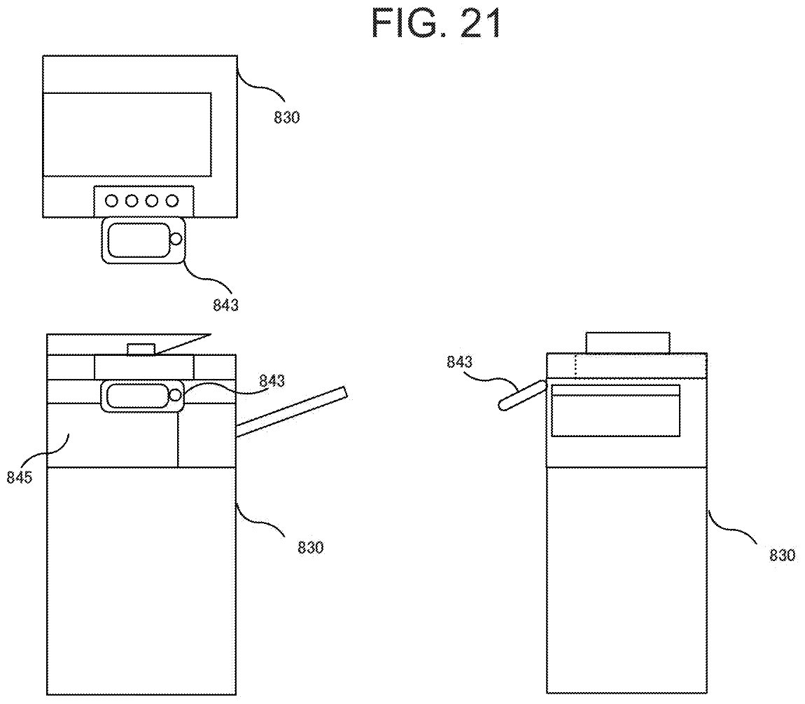

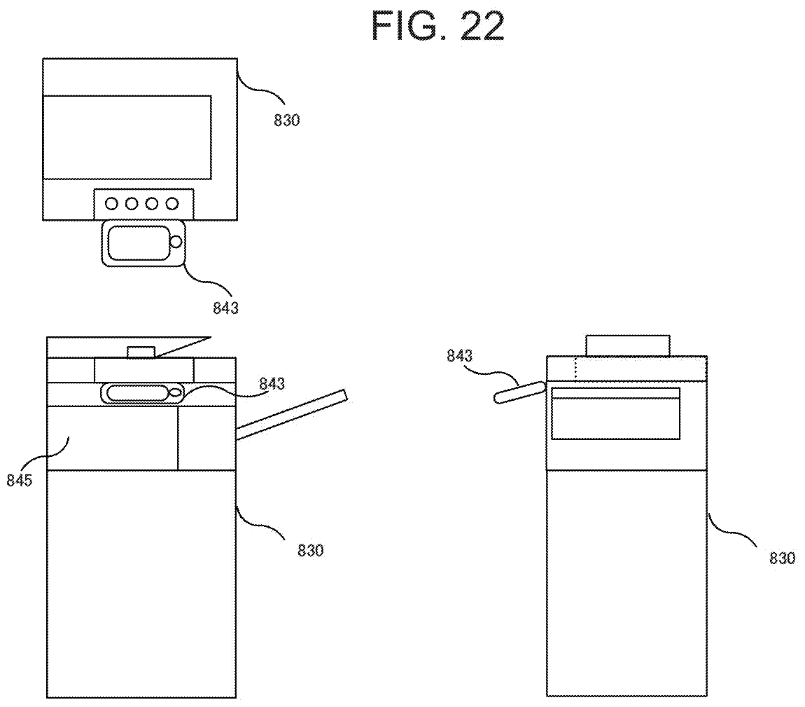

In a nineteenth embodiment, as illustrated in FIG. 21 or FIG. 22, the operation panel 843 is arranged at the top center of the front face of the main body 830, and operation buttons are arranged at the front center of the top face of the main body 830.

In the example illustrated in FIG. 21, the operation panel 843 hides a part of the entrance of the sheet discharger 845, but in the example illustrated in FIG. 22, the operation panel 843 does not hide a part of the entrance of the sheet discharger 845.

According to the present embodiment, the operation panel 843 is arranged to overlap with the sheet discharger 845 in the horizontal direction. Therefore, when the user takes out a printed copy sheet, the user easily visually recognizes a USB device inserted in the USB slot 321 arranged in the operation panel 843.

### Twentieth Embodiment

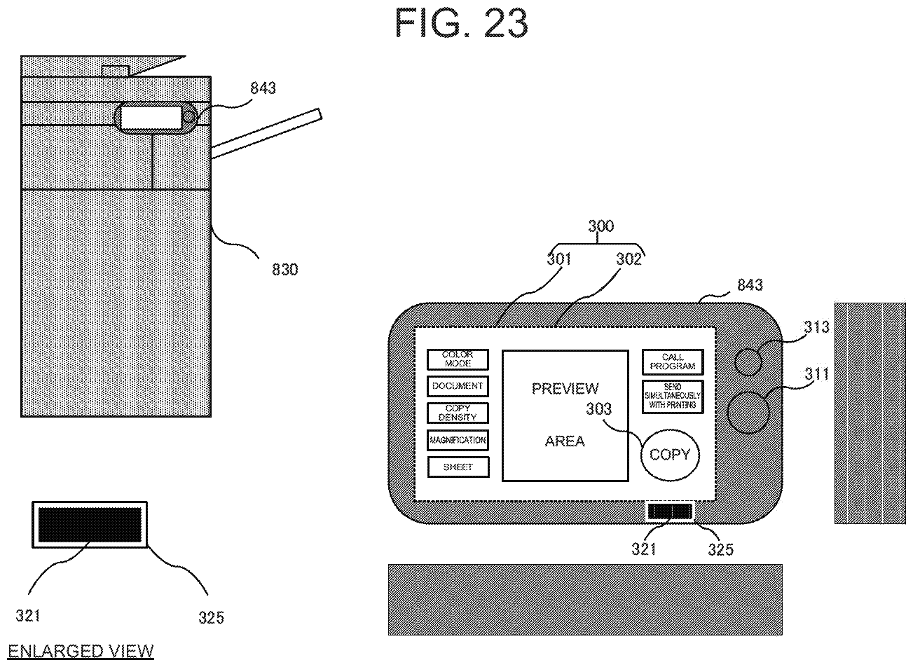

In a twentieth embodiment, as illustrated in FIG. 23, a USB slot periphery 325 provided around the USB slot 321 is designed in color different from the color of portions other than the touch panel 300 in the top face of the operation panel 843. In the example of FIG. 23, the color of the USB slot periphery 325 is lighter than the color of the portions other than the touch panel 300 in the top face of the operation panel 843. However, the color may be darker or another color tone.

This is applicable to possible embodiments of the first to nineteenth embodiments.

### Twenty-First Embodiment

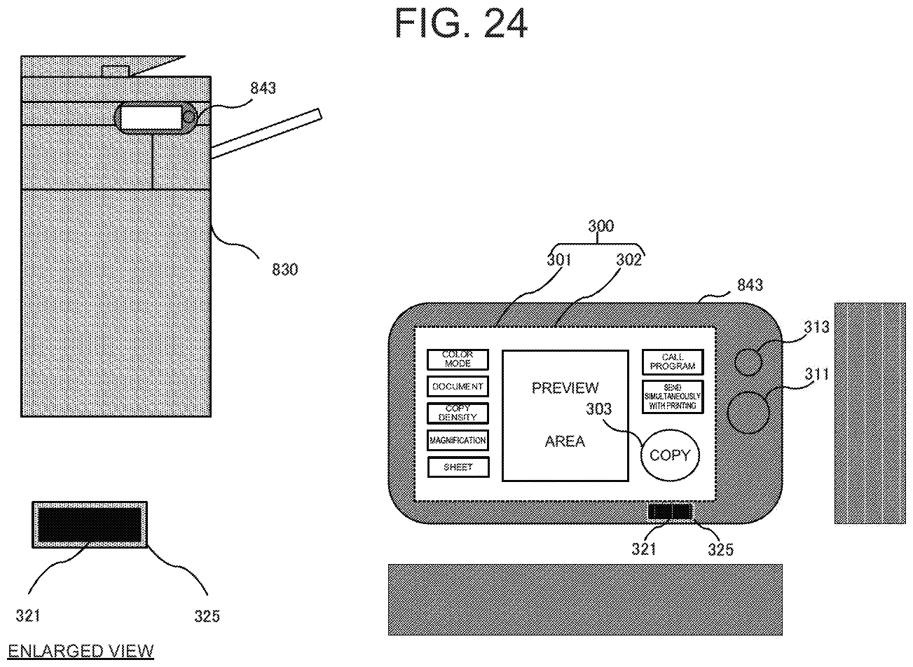

In a twenty-first embodiment, as illustrated in FIG. 24, the USB slot periphery 325 provided around the USB slot 321 is designed in color different from the color of portions other than the touch panel 300 in the top face of the operation panel 843.

In particular, the USB slot periphery 325 is designed in the same color as the main body 830. Here, the color of the portions other than the touch panel 300 in the top face of the operation panel 843 is different from the color of the main body 830.

This is applicable to possible embodiments of the first to twentieth embodiments.

### Twenty-second Embodiment

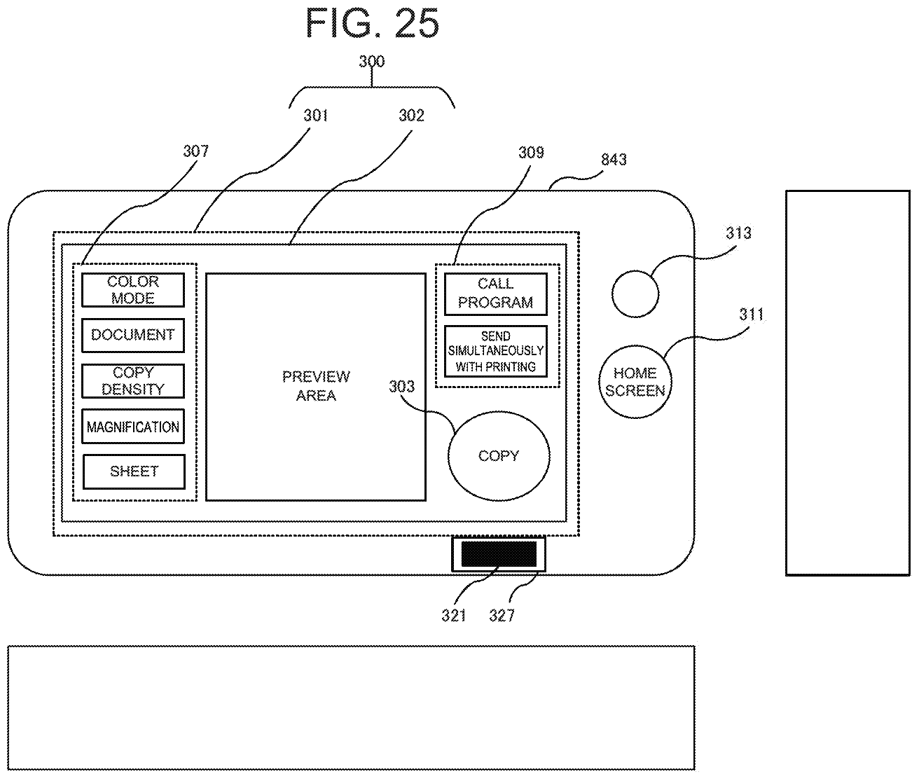

In a twenty-second embodiment, as illustrated in FIG. 25, a recess 327 is provided, in which the USB slot 321 is arranged.

This is applicable to possible embodiments of the first to twenty-first embodiments.

### Twenty-Third Embodiment

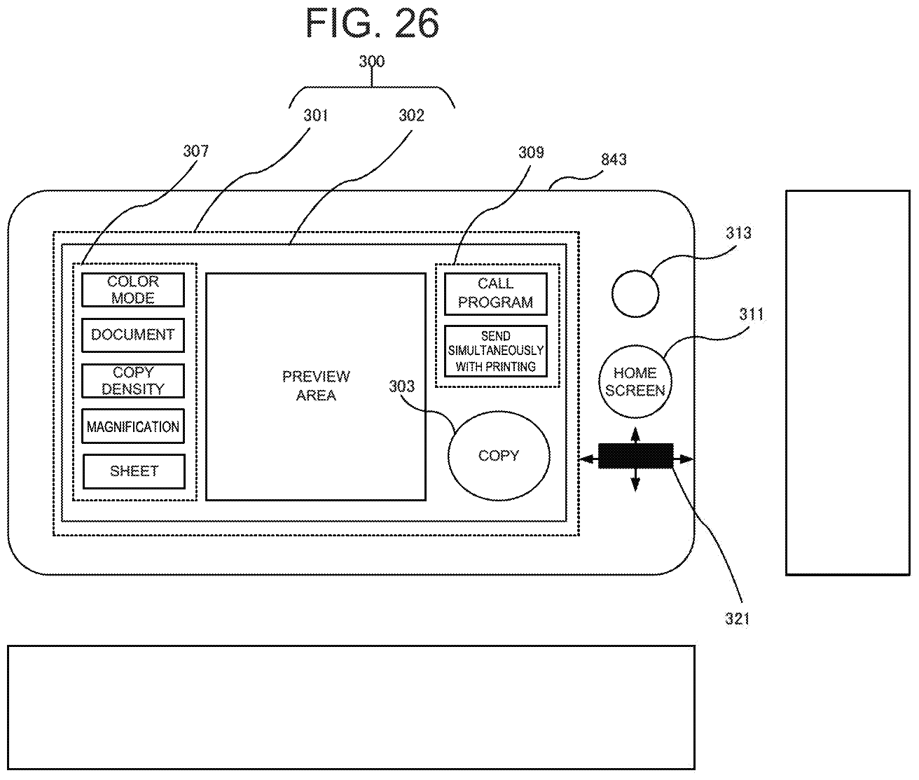

In the eighth embodiment illustrated in FIG. 9, the USB slot 321 is arranged at a position on the operation panel 843 between the position of the copy key 303, which is the largest-sized software key on the touch panel 300, as projected on a vertical side of the touch panel 300 and the position of the home screen button 311, which is the largest-sized hardware button on the operation panel 843. However, such a position may be any position within a predetermined range as indicated by up and down arrows in FIG. 26. In other words, the position on the operation panel 843 where the USB slot 321 is arranged can be freely chosen in design as long as the condition is satisfied in which the USB slot 321 is arranged at a position on the operation panel 843 between the position of the copy key 303, which is the largest-sized software key on the touch panel 300, as projected on a vertical side of the touch panel 300 and the position of the home screen button 311, which is the largest-sized hardware button on the operation panel 843.

This is applicable to possible embodiments of the first to twenty-second embodiments.

### Twenty-Fourth Embodiment

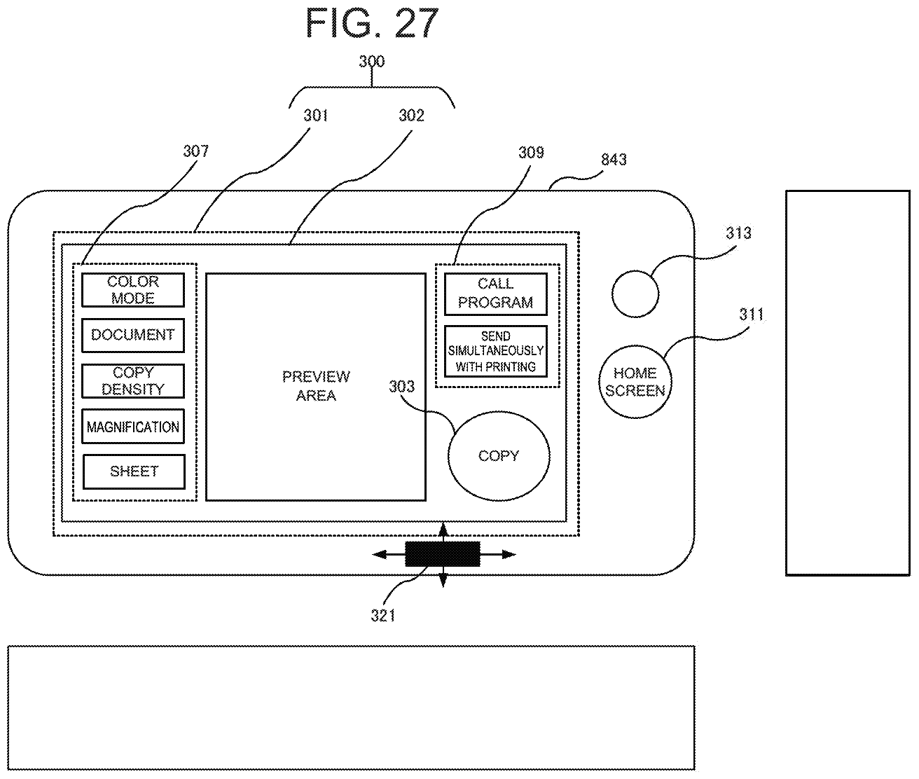

In the fourteenth embodiment illustrated in FIG. 16, the USB slot 321 is arranged at a position on the operation panel 843 close to a position between the copy key 303, which is the largest-sized software key, and the preview area 302 on the touch panel 300 as projected on a vertical side of the touch panel 300. However, such a position may be any position within a predetermined range as indicated by up and down arrows in FIG. 27. In other words, the position on the operation panel 843 where the USB slot 321 is arranged can be freely chosen in design as long as the condition is satisfied in which the USB slot 321 is arranged at a position on the operation panel 843 close to a position between the copy key 303, which is the largest-sized software key, and the preview area 302 on the touch panel 300 as projected on a vertical side of the touch panel 300.

This is applicable to possible embodiments of the first to twenty-third embodiments.

### Twenty-Fifth Embodiment

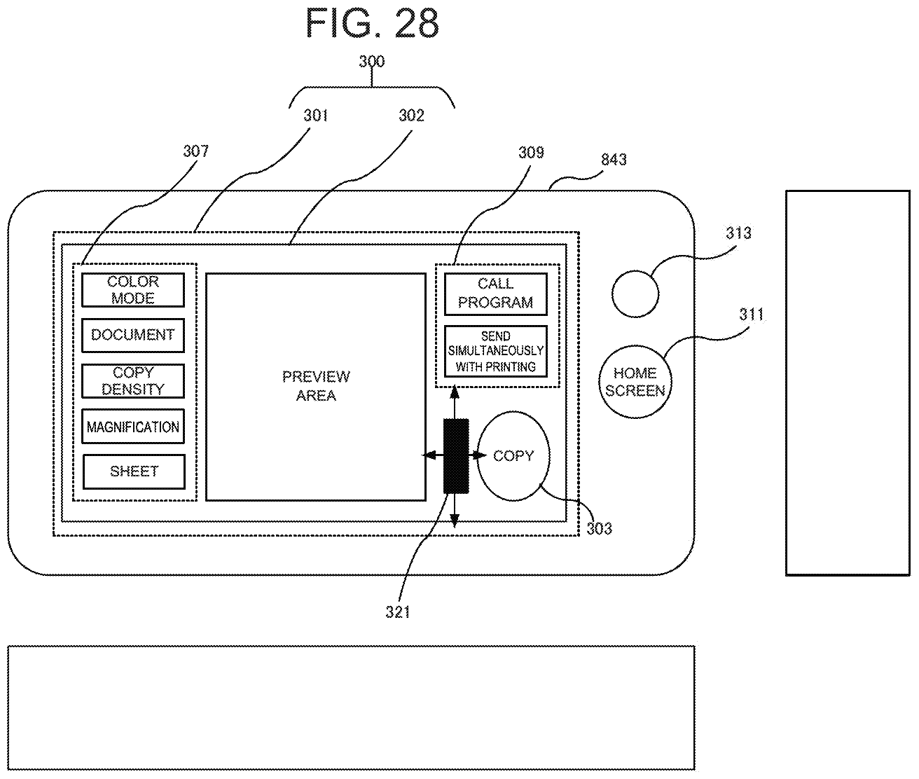

In the fifteenth embodiment illustrated in FIG. 17, the USB slot 321 is arranged at a position between the copy key 303, which is the largest-sized software key, and the preview area 302 on the touch panel 300. However, such a position may be any position within a predetermined range as indicated by up and down arrows in FIG. 28. In other words, the position on the operation panel 843 where the USB slot 321 is arranged can be freely chosen in design as long as the condition is satisfied in which the USB slot 321 is arranged at a position between the copy key 303, which is the largest-sized software key, and the preview area 302 on the touch panel 300.

This is applicable to possible embodiments of the first to twenty-forth embodiments.

### Twenty-Sixth Embodiment

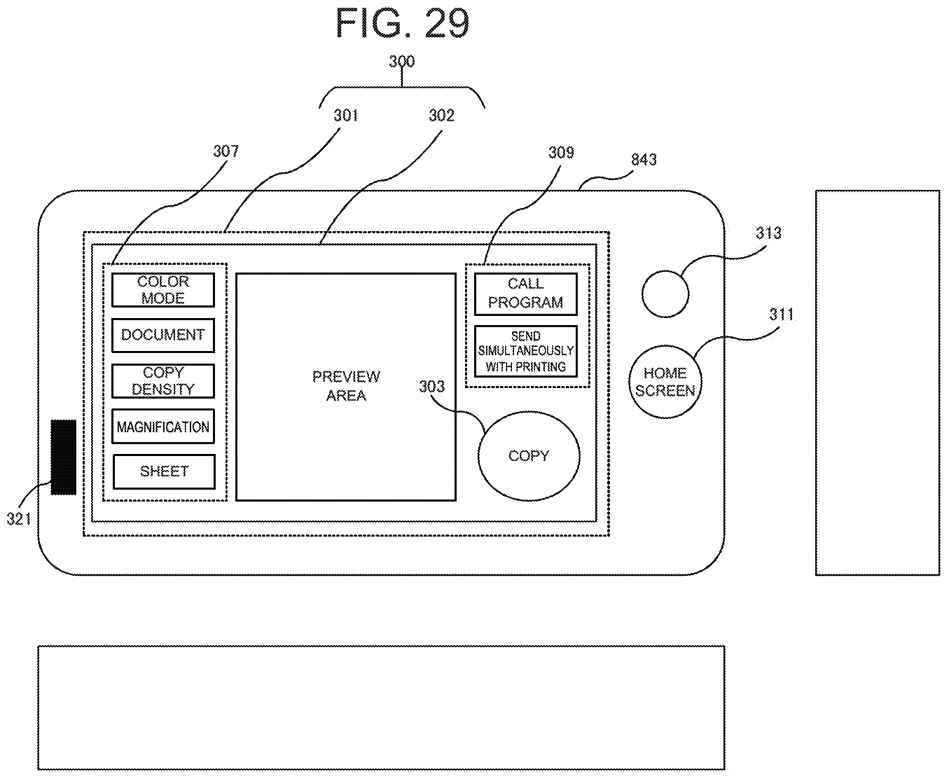

In a twenty-sixth embodiment, as illustrated in FIG. 29, on the top face of the operation panel 843, the USB slot 321 is arranged on the side opposite to the home screen button 311 in the right-left direction, which is the largest-sized software key, across the touch panel 300. In particular, in the example of FIG. 29, the USB slot 321 is arranged at the same height as the copy key 303 on the top face of the operation panel 843.

### Twenty-Seventh Embodiment

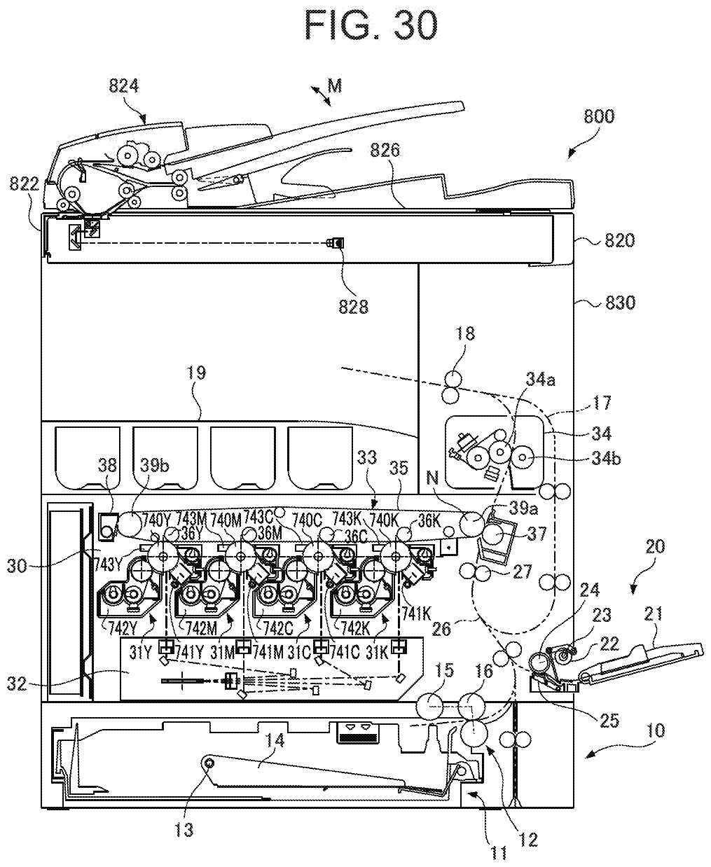

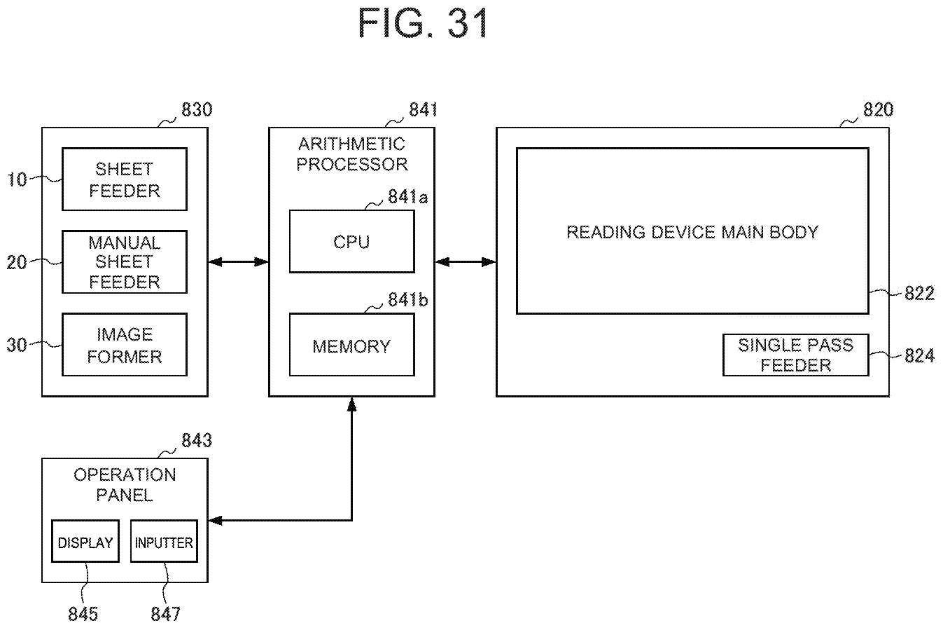

A twenty-seventh embodiment relates to a multifunctional apparatus 800 including the document reading device according to the first to twenty-sixth embodiments. FIGS. 30 and 31 illustrate configurations of the multifunctional apparatus 800.

As illustrated in FIGS. 30 and 31, the multifunctional apparatus 800 includes a document reading device 820 that reads an image of a document, a multifunctional apparatus main body (image former main body) 830 that forms an image on a sheet, the operation panel 843 for operating the document reading device 820 and the multifunctional apparatus main body 830, and an arithmetic processor 841 that controls the document reading device 820 and the multifunctional apparatus main body 830 based on an operation through the operation panel 843.

In addition to using the document reading device 820 alone for reading an image and using the multifunctional apparatus main body 830 alone for forming an image, the document reading device 820 and the multifunctional apparatus main body 830 can also be linked to copy an image. The multifunctional apparatus 800 may include a storage device and a facsimile device (not illustrated). The storage device can store an image read by the document reading device 820 and an image received by the facsimile device. The facsimile device can transmit an image read by the document reading device 820 and an image stored in the storage device, and can receive an image from the outside. Furthermore, the multifunctional apparatus 800 may include an interface for connecting to a personal computer via a network. The personal computer connected to the multifunctional apparatus 800 can use the function of the multifunctional apparatus for data to be managed.

The document reading device 820 includes a single pass feeder (SPF) 824, which is an automatic document feeder that automatically feeds a document, and a reading device main body 822 that reads an image of the document. It is noted that in addition to the components illustrated in FIG. 31, the document reading device 820 also includes components illustrated in FIG. 30 but not illustrated in FIG. 31. Further, as illustrated in FIG. 30, the reading device main body 822 includes a platen 826.

The multifunctional apparatus main body 830 includes a sheet feeder 10 that feeds sheets, a manual sheet feeder 20 that manually feeds sheets, and an image former 30 that forms an image on a sheet fed by the sheet feeder 10 or the manual sheet feeder 20.

The sheet feeder 10 includes a sheet stacker 11 in which sheets are stacked and a separation feeder 12 that separates and feeds the sheets stacked on the sheet stacker 11 one by one. The sheet stacker 11 includes an intermediate plate 14 that turns about a turning shaft 13. The intermediate plate 14 turns to lift a sheet upward when the sheet is fed. The separation feeder 12 includes a pickup roller 15 that feeds a sheet lifted by the intermediate plate 14 and a pair of separation rollers 16 that separates the sheet fed by the pickup roller 15 one by one.

The manual sheet feeder 20 includes a manual feed tray 21 on which sheets are stackable and a separation feeder 22 that separates and feeds the sheets stacked on the manual feed tray 21 one by one. The manual feed tray 21 is turnably supported by the multifunctional apparatus main body 830, and is fixed at a predetermined angle so that sheets can be stacked when a sheet is manually fed. The separation feeder 22 includes a pickup roller 23 that feeds sheets stacked on the manual feed tray 21, and a separation roller 24 and a separation pad 25 that separate the sheets fed by the pickup roller 23 one by one.

The image former 30 includes four process cartridges 31Y to 31K that form yellow (Y), magenta (M), cyan (C), and black (K) images, respectively, photoreceptor drums 740Y to 740K, which will be described later, an exposure device 32 that exposes the surfaces of the photoreceptor drums, a transferer 33 that transfers toner images formed on the surfaces of the photoreceptor drums 740Y to 740K onto a sheet, and a fixer 34 that fixes the transferred toner images onto the sheet. It is noted that the alphabets (Y, M, C, K) appended to the end of the reference numerals indicate the respective colors (yellow, magenta, cyan, black).

Each of the four process cartridges 31Y to 31K is removable from the multifunctional apparatus main body 830 to be replaceable. It is noted that since the four process cartridges 31Y to 31K have the same configuration except that the color of the image to be formed is different, only the configuration of the process cartridge 31Y that forms a yellow (Y) image will be described, and the explanation of the process cartridges 31M to 31K is omitted accordingly.

The process cartridge 31Y includes the photoreceptor drum 740Y serving as an image carrier, a charger 741Y that charges the photoreceptor drum 740Y, a developing device 742Y that develops an electrostatic latent image formed on the photoreceptor drum 740Y, and a drum cleaner 743Y that removes toner remaining on the surface of the photoreceptor drum 740Y. The developing device 742Y includes a developing device main body (not illustrated in detail) that develops the photoreceptor drum 740Y, and a toner cartridge (not illustrated in detail) that supplies toner to the developing device main body. The toner cartridge is attachable to and detachable from the developing device main body, and can be removed from the developing device main body and replaced when the stored toner runs out.

The exposure device 32 includes a light source (not illustrated) that emits laser light, a plurality of mirrors (not illustrated) that guide the laser light to the photoreceptor drums 740Y to 740K, and the like. The transferer 33 includes an intermediate transfer belt 35 that carries toner images formed on the photoreceptor drums 740Y to 740K, primary transfer rollers 36Y to 36K that primarily transfer the toner images formed on the photoreceptor drums 740Y to 740K onto the intermediate transfer belt 35, a secondary transfer roller 37 that secondarily transfers the toner images transferred onto the intermediate transfer belt 35 onto a sheet, and a belt cleaner 38 that removes toner remaining on the intermediate transfer belt 35. The intermediate transfer belt 35 is wound around a driving roller 39a and a driven roller 39b, and is pressed against the photoreceptor drums 740Y to 740K by the primary transfer rollers 36Y to 36K. The secondary transfer roller 37 nips the intermediate transfer belt 35 with the driving roller 39a, and transfers the toner image carried by the intermediate transfer belt 35 onto a sheet at a nip zone N. The fixer 34 includes a heating roller 34a that heats the sheet, and a pressure roller 34b that presses against the heating roller 34a.

The operation panel 843 includes a display 845 that displays predetermined information, and an inputter 847 that allows a user to input instructions to the document reading device 820 and the multifunctional apparatus main body 830. In the present embodiment, the operation panel 843 is arranged on the front side of the reading device main body 822. It is noted that the front side corresponds to the front side of the drawing sheet of FIG. 30, and the rear side corresponds to the back side of the drawing sheet of FIG. 30.

The display 845 includes the display area 301 of the touch panel 300. Further, the display 845 may include another display area.

The inputter 847 includes the touch area 302 of the touch panel 300. Further, the inputter 847 may include an input button and the like.

As illustrated in FIG. 31, the arithmetic processor 841 includes a CPU 841a that drives and controls the sheet feeder 10, the manual sheet feeder 20, the image former 30, and the document reading device 820, and a memory 841b that stores various programs for operating the CPU 841a, various information used by the CPU 841a, and the like. The arithmetic processor 841 integrally controls the operations of the sheet feeder 10, the manual sheet feeder 20, the image former 30, and the document reading device 820 based on an operation on the operation panel 843 by the user, to form an image on a sheet. Further, when a memory is inserted into the external recording medium slot, the arithmetic processor 841 receives a signal from the memory and thus detects that the memory has been inserted into the external recording medium slot. If detecting the memory, the arithmetic processor 841 changes display modes of the largest-sized software key arranged on the touch panel, the largest-sized hardware button arranged on the operation panel, and the like, and causes the touch panel to display a display object indicating the memory inserted.

Next, an image forming operation (image forming control by the arithmetic processor 841) performed by the multifunctional apparatus 800 configured as described above will be described. In the present embodiment, an example will be described in which the image former 30 forms an image of a document fed by the single pass feeder 824 and then read by the reading device main body 822 on a sheet fed by the sheet feeder 10.

When an image formation start signal is transmitted in response to a user input to the inputter 847 of the operation panel 843, a document to be read which is placed on the single pass feeder 824 by the user is automatically fed toward a document reading position, and the image is read at the document reading position by the reading device main body 822.

When the image of the document is read by the reading device main body 822, the exposure device 32 emits, to the photoreceptor drums 740Y to 740K, their respective laser beams, based on the image information of the read document. At this time, the photoreceptor drums 740Y to 740K are precharged by the chargers 741Y to 741K, respectively, and the exposure device 32 emits, to the photoreceptor drums 740Y to 740K, their respective laser beams to form their respective electrostatic latent images on the photoreceptor drums 740Y to 740K. Thereafter, the electrostatic latent images formed on the photoreceptor drums 740Y to 740K are developed by the developing devices 742Y to 742K to form yellow (Y), magenta (M), cyan (C), and black (K) toner images on the respective photoreceptor drums 740Y to 740K. The toner images of the respective colors formed on the photoconductive drums 740Y to 740K are superimposed and transferred onto the intermediate transfer belt 35 by the primary transfer rollers 36Y to 36K, and the superimposed and transferred toner image (full color toner image) is conveyed to the nip zone N while being carried on the intermediate transfer belt 35.

In parallel with the image forming operation described above, the sheets stacked on the sheet stacker 11 are fed to a sheet conveyance path 26 by the pickup roller 15 while being separated by the separation feeder 12 one by one. Then, the skew of the sheet is corrected by a pair of registration rollers 27 upstream of the nip zone N in the sheet conveyance direction, and the sheet is conveyed to the nip zone N at a predetermined conveyance timing. Onto the sheet conveyed to the nip zone N, the full color toner image carried by the intermediate transfer belt 35 is transferred by the secondary transfer roller 37.

The sheet onto which the toner image has been transferred is heated and pressed by the fixer 34 to melt and fix the toner image, and is discharged from the apparatus by a pair of discharge rollers 18. The sheet discharged from the apparatus is stacked on a discharge sheet stacker 19.

It is noted that if images are formed on both sides (a first side and a second side) of a sheet, the pair of discharge rollers 18 is reversely rotated to covey the sheet to a double-sided conveyance path 17 before the sheet of which the first side is formed with an image is discharged from the apparatus, and then, the sheet is conveyed to the image former 30 via the double-sided conveyance path 17 again. Next, similarly to the first side, an image is formed on the second side and the sheet is discharged from the apparatus. The sheet discharged from the apparatus is stacked on the discharge sheet stacker 19.

The present invention can be implemented in various other forms without departing from the spirit or main features thereof. Therefore, the embodiments described above are only examples, and should not be interpreted limitedly. The scope of the present invention is indicated by the claims, and is not restricted by the description of the specification. Further, all modifications and changes belonging to a scope equivalent to the claims are included within the scope of the present invention.

The present invention can be employed in a multifunctional apparatus. Further, the present invention can be employed in a device having a USB slot.

### DESCRIPTION OF REFERENCE NUMERALS

300 Touch panel

301 Display area

302 Touch area

303 Copy key

305 Preview area

307 Setting key group

309 Job key group

311 Home screen button

313 Power button

321 USB slot

323 USB storage

325 USB slot periphery

327 Recess

331 USB device

341 Speaker

830 Main body

843 Operation panel

845 Sheet discharger

What is claimed is:

1. A multifunctional apparatus comprising:
an operation panel on which a touch panel and a hardware button are arranged,
wherein an external recording medium slot is arranged on the operation panel having a predetermined relationship with a largest-sized software key arranged on the touch panel or a largest-sized hardware button arranged on the operation panel.

2. The multifunctional apparatus according to claim 1,
wherein the external recording medium slot is arranged at a position, on a top face of the operation panel, adjacent to the largest-sized software key arranged on the touch panel.

3. The multifunctional apparatus according to claim 1,
wherein the external recording medium slot is arranged at a position, on a top face of the operation panel, adjacent to the largest-sized software key arranged on the touch panel and a preview area arranged on the touch panel.

4. The multifunctional apparatus according to claim 1,
wherein the external recording medium slot is arranged at a position, on the touch panel, adjacent to the largest-sized software key arranged on the touch panel and a preview area arranged on the touch panel.

5. The multifunctional apparatus according to claim 1,
wherein the external recording medium slot is arranged at a position, on a top face of the operation panel, adjacent to a preview area arranged on the touch panel.

6. The multifunctional apparatus according to claim 1,
wherein the external recording medium slot is arranged at a position, on a top face of the operation panel, adjacent to the largest-sized hardware button arranged on the top face of the operation panel.

7. The multifunctional apparatus according to claim 1,
wherein the external recording medium slot is arranged at a position, on a side surface of the operation panel, adjacent to the largest-sized software key arranged on the touch panel.

8. The multifunctional apparatus according to claim 1,
wherein the external recording medium slot is arranged at a position, on a side surface of the operation panel, adjacent to the largest-sized hardware button arranged on the top face of the operation panel.

9. The multifunctional apparatus according to claim 1,
wherein the external recording medium slot is arranged at a position, on a top face of the operation panel, adjacent to the largest-sized software key arranged on the touch panel and adjacent to the largest-sized hardware button arranged on the top face of the operation panel.

10. The multifunctional apparatus according to claim 1,
wherein if a memory is inserted into the external recording medium slot, a display mode of the largest-sized software key arranged on the touch panel is changed.

11. The multifunctional apparatus according to claim 1,
wherein if a memory is inserted into the external recording medium slot, a display mode of the largest-sized hardware button arranged on the operation panel is changed.

12. The multifunctional apparatus according to claim 1,
wherein if a memory is inserted into the external recording medium slot, a display object indicating that the memory is inserted is displayed on the touch panel.

13. The multifunctional apparatus according to claim 1,
wherein if a predetermined job related to a memory inserted into the external recording medium slot is completed, a message indicating that the predetermined job is completed is displayed on the touch panel.

14. The multifunctional apparatus according to claim 1,
wherein if a predetermined job related to a memory inserted into the external recording medium slot is completed, a voice message indicating that the predetermined job is completed is output from the touch panel.

15. The multifunctional apparatus according to claim 1,
wherein a memory insertion port having the external recording medium slot as an entrance is arranged, the memory insertion port extending from a front side to a rear side of the operation panel along from a top to a bottom of the memory insertion port as viewed from a side of the operation panel.

16. The multifunctional apparatus according to claim 1,
wherein the operation panel is arranged in a middle zone as viewed from a front side of the multifunctional apparatus.

17. The multifunctional apparatus according to claim 1,
wherein the operation panel is provided in a range from an upper portion near a middle zone of a front face of the multifunctional apparatus to a front portion near a middle zone of a top face of the multifunctional apparatus.

18. The multifunctional apparatus according to claim 16,
wherein the operation panel is arranged to avoid a sheet discharger provided in the multifunctional apparatus.

19. The multifunctional apparatus according to claim 1,
wherein the external recording medium slot is surrounded by a periphery having a color different from a color of a top face of the operation panel.

20. The multifunctional apparatus according to claim 19,
wherein the color of the periphery is the same as a color of a main body of the multifunctional apparatus.
